(19) United States
(12) Patent Application Publication
(10) Pub. No.: US 2026/0037857 A1
(43) Pub. Date: Feb. 5, 2026

(54) METHOD, DEVICE AND SYSTEM FOR TRAINING AN ADAPTIVE UTILITY ARTIFICIAL INTELLIGENCE (AI) MODEL IN A VIRTUAL GAMING AND/OR A SIMULATION ENVIRONMENT

(71) Applicants: Maciej Swiechowski, Otwock (PL); Rafal Tyl, Warsaw (PL); Dominik Slezak, Warsaw (PL)

(72) Inventors: Maciej Swiechowski, Otwock (PL); Rafal Tyl, Warsaw (PL); Dominik Slezak, Warsaw (PL)

(21) Appl. No.: 18/790,140

(22) Filed: Jul. 31, 2024

(51) Int. Cl. G06N 20/00

(52) U.S. Cl. CPC G06N 20/00

(57) ABSTRACT

A method, a device and a system of training an adaptive utility AI model in a virtual gaming and/or a simulation environment is disclosed. In accordance therewith, the adaptive utility AI model is trained using one or more utility AI algorithms with data solely generated from a bot as an agent interacting with the virtual environment to generate a computational graph. A number of consideration nodes, utility curve nodes, aggregator nodes and a selector node are implemented through the computational graph. The selector node is utilized to select a behavior out of a set of behaviors applicable to the virtual environment as an appropriate behavior of the agent in the virtual environment in accordance with the implementation of the computational graph.

### FIELD OF TECHNOLOGY

This disclosure relates generally to utility Artificial Intelligence (AI) systems and, particularly, to a method, a system and/or a device for training an adaptive utility AI model in a virtual gaming and/or a simulation environment.

### BACKGROUND

Utility theory is a concept that lies at the cross-section of mathematics, economics/econometrics and behavioral psychology, and may be directed to design and/or expression of characters in electronic gaming environments that subsume Artificial Intelligence (AI)-based contexts. Approaches influenced by utility theory may be applied to implement decision mechanisms of agents in virtual/virtualized multimedia environments. Examples of such environments may include but are not limited to games and training simulations executing on data processing devices/virtual machines.

In a typical context, the end user (e.g., a game/training simulation development company) may want to control objects (e.g., game characters) in a game and/or a training simulation in a virtual multimedia environment. Typical modeling of game/simulation states involves invoking AI to effect transitions across said states using Finite State Machines (FSMs). However, when the states are complex and numerous, even with the expansion of hierarchical structures for management thereof, the states are difficult to debug.

The concept of hierarchical organization may extend to organizing game/simulation tasks in behavioral trees that are tree structures. However, the conditionality requirements of exiting the sub-trees may place the system within the same FSM context of handling numerous state transitions. Consequently, while behavior trees solve the problem of organization of behaviors, they may not provide for improved decision-making.

### SUMMARY

Disclosed are a method, a system and/or a device for training an adaptive utility Artificial Intelligence (AI) model in a virtual gaming and/or a simulation environment.

In one aspect, a method of a data processing device executing one or more utility AI algorithms is disclosed. The method includes training, using the one or more utility AI algorithms, the adaptive utility AI model with data generated solely from a bot as an agent interacting with a virtual environment offered by a gaming and/or a simulation application to generate a computational graph as the adaptive utility AI model in accordance with, implementing as part of the computational graph, a number of consideration nodes that each has a state of the virtual environment input thereto and outputs a numeric value representative of the state of the virtual environment.

The computational graph also includes a number of utility curve nodes, each of which transforms the output numeric value into another numeric value, a number of aggregator nodes, each of which has numeric values from a subset of the number of utility curve nodes input thereto and outputs exactly one numeric value therefrom, and a selector node to process outputs of the number of aggregator nodes and a set of behaviors applicable to the virtual environment in accordance with magnitudes of input numeric values associated therewith. The method also includes selecting, through the selector node, a behavior out of the set of behaviors applicable to the virtual environment as an appropriate behavior of the agent in the virtual environment in accordance with the implementation of the computational graph.

In another aspect, a data processing device includes a memory including instructions associated with one or more utility AI algorithms stored therein, and a processor communicatively coupled to the memory to execute the instructions associated with the one or more utility AI algorithms stored in the memory to train an adaptive utility AI model with data generated solely from a bot as an agent interacting with a virtual environment offered by a gaming and/or a simulation application to generate a computational graph as the adaptive utility AI model. In accordance therewith, a number of consideration nodes that each has a state of the virtual environment input thereto and outputs a numeric value representative of the state of the virtual environment is implemented as part of the computational graph.

The computational graph implemented also includes a number of utility curve nodes, each of which transforms the output numeric value into another numeric value, a number of aggregator nodes, each of which has numeric values from a subset of the number of utility curve nodes input thereto and outputs exactly one numeric value therefrom, and a selector node to process outputs of the number of aggregator nodes and a set of behaviors applicable to the virtual environment in accordance with magnitudes of input numeric values associated therewith. The processor also executes instructions associated with the one or more utility AI algorithms to select, through the selector node, a behavior out of the set of behaviors applicable to the virtual environment as an appropriate behavior of the agent in the virtual environment in accordance with the implementation of the computational graph.

In yet another aspect, a computing system includes a server including instructions associated with one or more utility AI algorithms stored therein, and a client device communicatively coupled to the server. The server executes the instructions associated with the one or more utility AI algorithms to train an adaptive utility AI model with data generated solely from a bot as an agent at the client device interacting with a virtual environment offered by a gaming and/or a simulation application to generate a computational graph as the adaptive utility AI model in accordance with, implementing as part of the computational graph: a number of consideration nodes that each has a state of the virtual environment input thereto and outputs a numeric value representative of the state of the virtual environment.

The computational graph also includes a number of utility curve nodes, each of which transforms the output numeric value into another numeric value, a number of aggregator nodes, each of which has numeric values from a subset of the number of utility curve nodes input thereto and outputs exactly one numeric value therefrom, and a selector node to process outputs of the number of aggregator nodes and a set of behaviors applicable to the virtual environment in accordance with magnitudes of input numeric values associated therewith. The server also executes instructions associated with the one or more utility AI algorithms to select, through the selector node, a behavior out of the set of behaviors applicable to the virtual environment as an appropriate behavior of the agent in the virtual environment in accordance with the implementation of the computational graph.

The methods and systems disclosed herein may be implemented in any means for achieving various aspects, and may be executed in a form of a machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of accompanying drawings, in which like references indicate similar elements and in which:

FIG. 1 is a schematic view of an example topological structure utilized in an example utility Artificial Intelligence (AI) model.

FIG. 2 is an example utility curve in a gaming context.

FIG. 3 is a schematic view of a virtual data processing environment, according to one or more embodiments.

FIG. 4 is a schematic view of a data processing device associated with an agent communicatively coupled to another data processing device of the virtual data processing environment of FIG. 3, according to one or more embodiments.

FIG. 5 is a schematic view of a tree structure associated with a Monte Carlo Tree Search (MCTS) algorithm implemented as part of utility AI algorithms in the virtual data processing environment of FIGS. 3-4.

FIG. 6 is a schematic view of operations performed on a topological structure of a utility AI model of the virtual data processing environment of FIGS. 3-5 through execution of an evolutionary algorithm and a stochastic gradient descent (SGD) algorithm, according to one or more embodiments.

FIG. 7 is a plot of optimizable parameters of which gradients are computed using the SGD algorithm of FIG. 6.

FIG. 8 is a schematic view of a computational graph of an adaptive utility AI model of the virtual data processing environment of FIGS. 3-6, according to one or more embodiments.

Other features of the present embodiments will be apparent from the accompanying drawings and from the detailed description that follows.

### DETAILED DESCRIPTION

Example embodiments, as described below, may be used to realize training of an adaptive utility Artificial Intelligence (AI) model in a virtual gaming and/or a simulation environment. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

Utility theory is a concept that lies at the cross-section of mathematics, economics/econometrics and behavioral psychology. While “utility” in the context of the present application is directed to design and/or expression of electronic gaming environments, exemplary embodiments discussed herein subsume utility contexts in the area of Artificial Intelligence (AI) and interactive multimedia environments including but not limited to gaming environments. Utility-based AI may subsume contexts where game characters are designed and behaviors thereof expressed. In other words, approaches influenced by utility theory may be applied to implement decision mechanisms of agents in virtual/virtualized multimedia environments. Examples of such environments may include but are not limited to games and training simulations executing on data processing devices/virtual machines.

In a typical context, the end user (e.g., a game/training simulation development company) with respect to concepts discussed herein may want to control objects (e.g., game characters) in a game and/or a training simulation in a virtual multimedia environment. The modeling of intelligent behavior of the game objects may have as a requirement the reduction in the time taken for human players to infer the behavior of the aforementioned objects. Typical modeling of game/simulation states involves invoking Artificial Intelligence (AI) to effect transitions across said states using Finite State Machines (FSMs). However, when the states are complex and numerous, even with the expansion of hierarchical structures for management thereof, the states are difficult to debug.

The concept of hierarchical organization may extend to organizing game/simulation tasks in behavioral trees that are tree structures. Here, decision-making may involve evaluation of a particular behavior or a set of behaviors to execute at a specific rate. The execution state may be changed to reflect any change in behavior chosen that is different from the immediately previous one invoked. This avoids the tedium of getting stuck in an execution state and experiencing bugs associated with state changes. However, the conditionality requirements of exiting the sub-trees may place the system within the same FSM context of handling numerous state transitions.

On the whole, while behavior trees solve the problem of organization of behaviors, they may not provide for improved decision-making because the process is locked to conditional nodes without specifying how decisions are made to invoke different sub-trees discussed above.

Exemplary embodiments discussed herein provide for improved-decision making in virtual game/simulation environments. A virtual environment may characteristically be modeled as a partially observable Markov Decision Process (MDP). The state of the virtual environment may be fully represented by an arbitrary set of numeric values. During simulation of human behavior and/or interaction with the virtual environment by an agent (e.g., a human user, a bot, a programmed physical robot implementation, a set of adaptive/standalone test instructions), this state may be stored on a non-transitory medium such as a memory (e.g., a volatile and/or a non-volatile memory) of one or more data processing device(s) (e.g., a server, a client device, a mobile phone, a smart device). In each state, the agent may have up to K available actions but may be able to execute at most one of the K available actions.

The state may be updated in response to the actions executed by the agent and/or as part of the simulation of the environment. As the aforementioned actions are performed on a data processing device/digital medium such as a laptop, desktop computer, a client device, a game console, a mobile device such as a smartphone and a portable smart device, the virtual environment may often be a computer game. The fundamental assumption in the utility AI concept applied to the computer game may be that the notion of utility is introduced as a universal measure for comparing alternative available options (e.g., actions, behaviors). It is to be noted that the terms “action” and “behavior” may be used interchangeably in the context of agents in video games. Traditionally, actions may tend to be atomic, while behaviors may be more general in that, for example, behaviors may compromise sequences of atomic actions in the environment.

Utility AI may be employed to compute utility values for each behavior discussed herein and then select one or more behavior(s) such that the selected one or more behavior(s) is positively correlated to a corresponding one or more utility value(s) thereof. Conventionally, utility may correspond to real, non-negative values. The lowest value of utility may be zero, which is interpreted as being associated with “no utility.” Thus, utility values may typically vary between 0 and ∞. Utility AI may be regarded as a model and/or may encompass a set of specific computational procedures utilizing said model. Utility AI may have two aspects thereto: (i) a computational procedure or a set of computational procedures (e.g., one or more algorithm(s)), and (ii) a topological structure. The set of computational procedures and the topology/topological structure together may form a utility AI model. The utility AI model may be inferred, i.e., the set of computational procedures may be executed, using the topological structure.

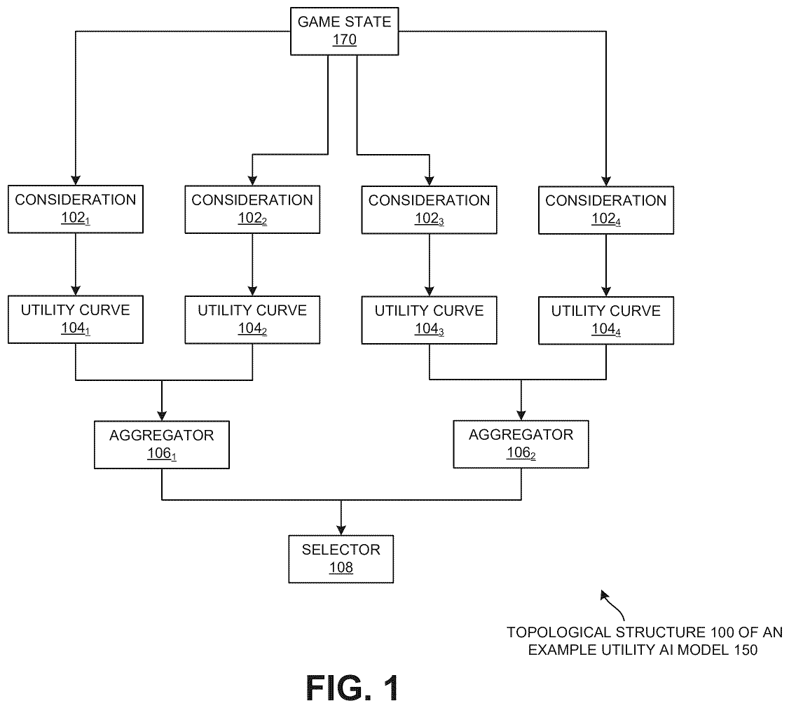

FIG. 1 shows an example topological structure 100 utilized in an example utility AI model 150. Topological structure 100 may be a hierarchy of a number of elements shown in FIG. 1. A consideration 102₁₋₄ may represent a subset of a state (e.g., game state 170) of a given context (e.g., gaming/simulation context). From the perspective of the one or more algorithm(s) discussed above, considerations 102₁₋₄ may be worth being considered during score calculations. Example considerations 102₁₋₄ may include but are not limited to health of an agent, health of an opponent, distance between agents, damage to weapons of the agent. Considerations 102₁₋₄ may arise based on the necessity of evaluating contexts involving, for example, behavior of opponents. Here, considerations 102₁₋₄ associated with “attack” behaviors may involve health parameters and “fleeing” behavior health of the agents and distance therebetween.

Example contexts involving “attacks” may include but are not limited to characters/agents being at full health or very “low” health. The “lesser” the health of the opponent, the more likely the agent may be to attack. An example context involving “fleeing” behavior may include but is not limited to an opponent getting close to a character/agent. The lesser the health of the opponent, the more likely the agent may be to attack. “Fleeing” may be executed whenever the opponent may come too close to the agent and/or may be likelier with every tier of increased health loss.

Considerations 102₁₋₄ may take the form of any data type. In an example implementation, considerations 102₁₋₄ may take numeric values from 0 to 100. Considerations 102₁₋₄ may provide input data that are measurable properties of a current state of an agent or an environment (e.g., including opponents) thereof. In one or more embodiments, considerations 102₁₋₄ may be passed through utility curves 104₁₋₄ that perform transformations of values thereof. A utility curve 104₁₋₄ may also be referred to as a “response curve” and may define the relationship between the utility of a particular action given the values of a particular consideration 10214. Utility curve 10414 may transform a current value of a consideration 10214 into the utility of an action given said consideration 102₁₋₄.

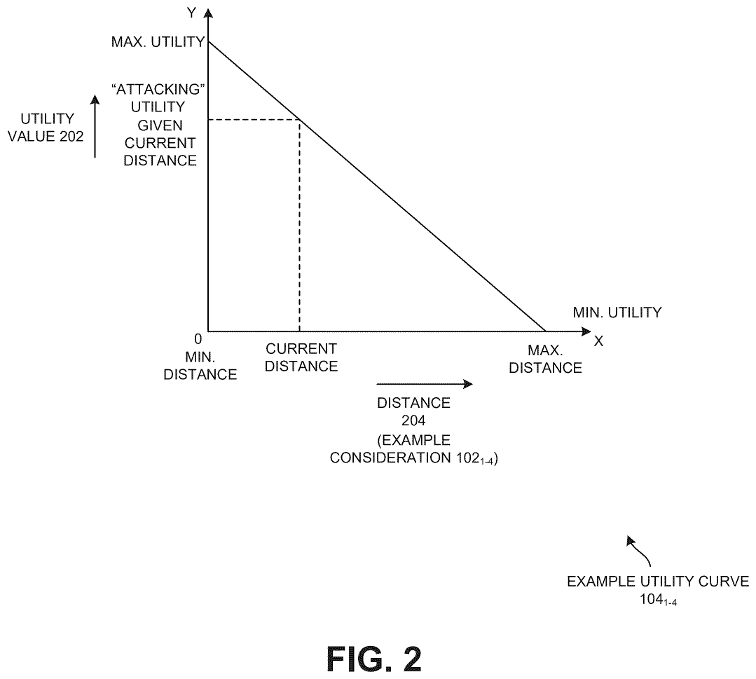

FIG. 2 shows an example utility curve 10414 that represents “attacking” utility (e.g., expressed as utility value 202) given a distance 204 of an agent from an enemy character. As clearly seen, utility value 202 decreases from a maximum when distance 204 is minimum to a minimum when distance 204 is maximum. Referring back to FIG. 1, topological structure 100 may have aggregators 106₁₋₂, each of which combines outputs (e.g., multiple numeric values) from multiple utility curves 104₁₋₄ (e.g., per consideration 102₁₋₄) into a final utility (e.g., another numeric value) of a specific action. Said final utility may be called “marginal utility” and may be analogous to “marginal probability,” which is independent of other events, i.e., which is global and not conditional.

A selector 108 may receive the output from aggregators 106₁₋₂ that represents the utility of a respective action and provides the action (e.g., one of the evaluated contexts) that the agent should choose as an output thereof. Exemplary embodiments provide for the first method and the methodology to train utility AI models from data in a virtual environment. Data, as discussed herein, may refer to but are not limited to historical data (e.g., past data), states, measures of the virtual environment, descriptions of the virtual environment, actions and behavioral parameters (e.g., behaviors 322 that are applicable across the entirety of this patent application). Specifically, exemplary embodiments may be related to creation of a topological structure and specific parametrization thereof that are utilizable by a utility AI algorithm.

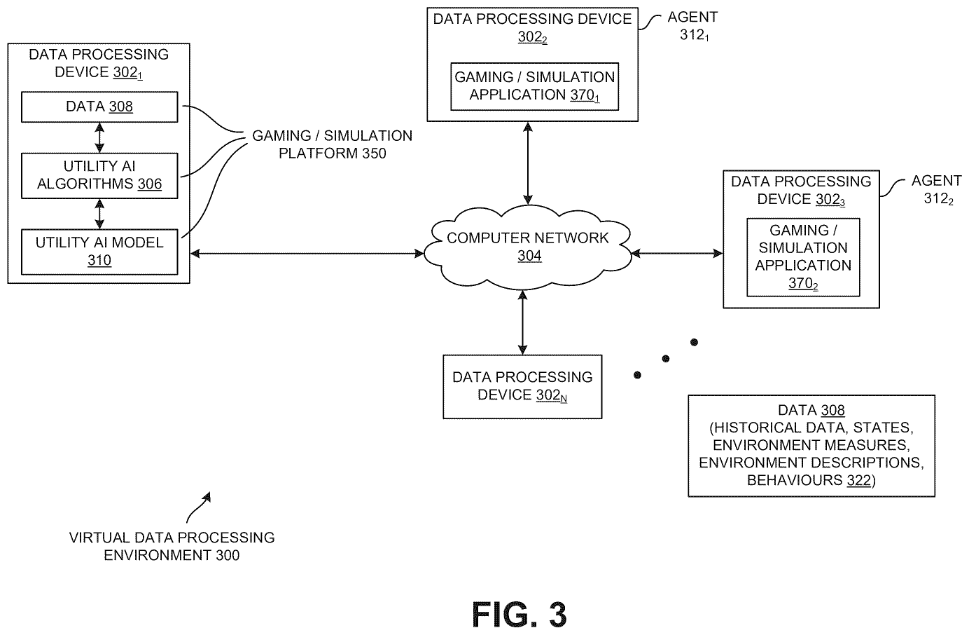

In one or more embodiments, “method” as referred to herein may imply a training algorithm, and “methodology” as referred to herein may refer to the whole process starting from the way the virtual environment is prepared to how the training data is generated to obtain a final utility AI model. FIG. 3 shows a virtual data processing environment 300, according to one or more embodiments. In one or more embodiments, virtual data processing environment 300 may include a number of data processing devices 302_{1-N} communicatively coupled to one another through a computer network 304 (e.g., a Wide Area Network (WAN), a Local Area Network (LAN), a mobile network, a private network, a short-range communication protocol-based network). In one or more embodiments, one or more data processing device(s) 302_{1-N} (e.g., just data processing device 302₁, as shown in FIG. 3, for the sake of example) may execute one or more utility AI algorithm(s) 306 thereon on data 308 discussed herein to generate an adaptive utility AI model 310.

In one or more embodiments, data processing device 302₁ may be a server or any other form of data processing device. In FIG. 3, for the sake of example, data processing devices 302_{2-N} may be client devices (e.g., laptops, desktop computers, mobile phones, smart data processing devices, portable smart devices) at which agents may interact with a virtual environment provided via data processing device 302₁. As seen in FIG. 3, in one or more embodiments, data processing device 302₁ may offer a gaming/simulation platform 350 thereon that provides data 308 to utility AI algorithms 306, as will be discussed herein. While FIG. 3 shows agents 312₁₋₂ at data processing devices 302₂₋₃ merely for the sake of example, it should be noted that multiple agents may execute at the same or many different data processing devices 302_{2-N}.

In one or more embodiments, each data processing device 302₂₋₃ may execute a component of gaming/simulation platform 350 as gaming/simulation application 370₁₋₂. It should be noted that data processing device 302₂₋₃ may also offer a virtual machine (VM)-based environment in which an abstracted form of gaming/simulation application 370₁₋₂ offered by the underlying physical hardware (e.g., data processing device 302₁) may be executed. All reasonable variations are within the scope of the exemplary embodiments discussed herein. In one or more embodiments, the training method and methodology of utility AI model 310 may include three phases: (i) data generation including preparation of the virtual environment, (ii) training utility AI model 310, and (iii) applying the trained utility AI model 310 to a game/simulation experienced through the execution of gaming/simulation application 370₁₋₂. In one or more embodiments, the data generation phase may work only with bots or test humans/agents as agents 312₁₋₂. In one or more embodiments, in the phase of training utility AI model 310, training algorithms as part of utility AI algorithms 306 may be utilized. In one or more embodiments, the best utility AI model 310 found in the training phase may be serialized and incorporated into the actual game/simulation.

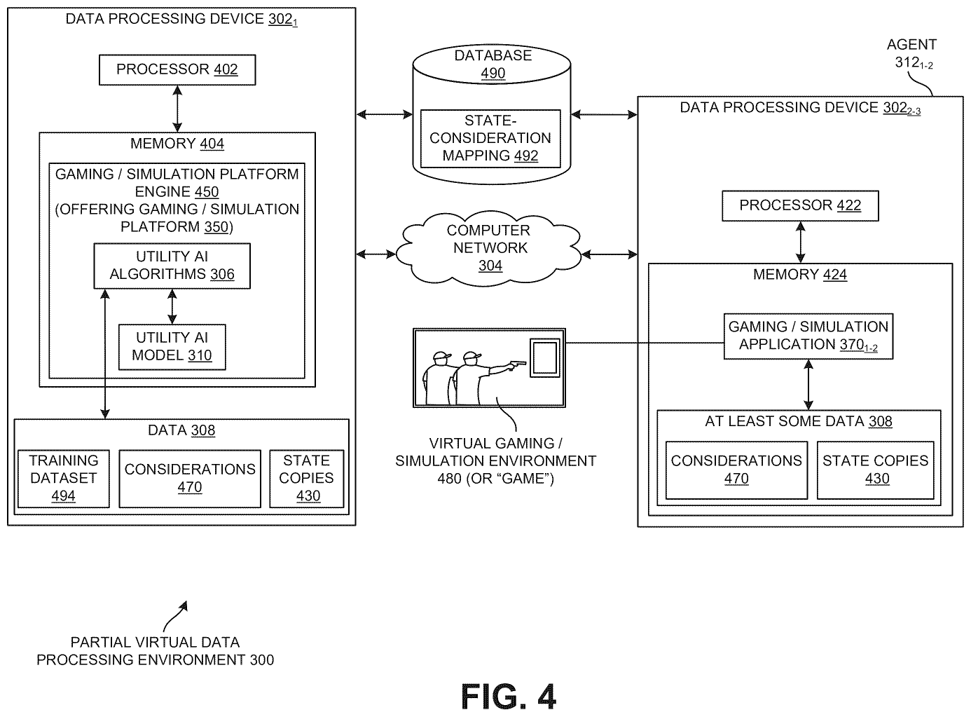

FIG. 4 shows an example data processing device 302₂₋₃ associated with agent 312₁₋₂ communicatively coupled to data processing device 302₁. In one or more embodiments, as seen in FIG. 4, gaming/simulation platform 350 may be offered through data processing device 302₁ based on execution of a gaming/simulation platform engine 450 thereon. In one or more embodiments, data processing device 302₁ may include a processor 402 (e.g., a standalone processor, a network/cluster of processors, a number of processor cores) communicatively coupled to a memory 404 (e.g., a volatile and/or a non-volatile memory) in which gaming/simulation platform engine 450 may be stored for execution through processor 402. In one or more embodiments, utility AI algorithms 306 be part of gaming/simulation platform engine 450 in memory 404; utility AI algorithms 306 may utilize data 308 stored in memory 404 for execution thereof to generate utility AI model 310.

FIG. 4 also shows data processing device 302₂₋₃ as having a processor 422 communicatively coupled to a memory 424 (e.g., a volatile and/or a non-volatile memory); memory 424 may include gaming/simulation application 370₁₋₂ that executes on processor 422. In one or more embodiments, the execution of gaming/simulation application 370₁₋₂ provided through gaming/simulation platform engine 450 may cause an interaction with a virtual gaming/simulation environment 480 (or, “game” hereinafter) provided therethrough. In one or more embodiments, as discussed above, the data generation phase may begin with the game being configured to operate entirely with bots as agents 312₁₋₂. In one or more embodiments, if human participation is required, agents 312₁₋₂ (e.g., bots) may assume the role thereof during the training phase.

In one or more embodiments, given that the game solely involves bots as agents 312₁₋₂, all rendering or at least some portion thereof (e.g., including graphical user interfaces (GUIs) associated with the game/gaming/simulation environment 480 may be disabled through gaming/simulation platform engine 450. In one or more embodiments, rendering may relate to generate computationally intensive elements associated with the game/gaming environment 480 including but not limited to two-dimensional and/or three-dimensional characters, objects and/or GUIs. So, in one or more embodiments, the execution of gaming/simulation application 370₁₋₂ (e.g., on data processing device 302₂₋₃/VM(s)) may be limited based on the disabling at least some portion of rendering through gaming/simulation platform engine 450.

In one or more embodiments, for path planning of bots as agents 312₁₋₂, a Monte Carlo Tree Search (MCTS) algorithm may be employed as part of utility AI algorithms 306. It should be noted that any planning-based algorithm may be employed instead of the MCTS algorithm, provided the stringent requirements are met. Path planning of bots, as discussed herein, may refer to planning of sequences of actions of the bots with reference to the game by which optimized paths from initial states to destination states are obtained and refined. In one or more embodiments, as bots may require sufficient processing time to deliberate and make informed decisions, the virtual “in-game” time may be increased, i.e., the passage of time experienced by the bots during the game may be slowed down (e.g., through gaming/simulation platform engine 450), for example by a factor of 50-100, compared to real-time. In one or more embodiments, while such deceleration may be unacceptable in a final release version of gaming/simulation application 370₁₋₂, it may be acceptable during the phase of data generation as the game is solely bot-driven. In one or more embodiments, the deceleration may be utilized to increase the strength of participating agents 312₁₋₂ and, therefore, the accuracy of ground truths to be modeled with utility AI algorithms 306 and to generate one or more baseline reference(s) against which performance of utility AI model 310 may be measured.

In one or more embodiments, a mapping (e.g., assignment) between states of an MCTS algorithm (e.g., part of utility AI algorithms 306; or states of virtual gaming/simulation environment 480) to values (e.g., numeric) associated with considerations 470 (e.g., analogous to consideration 102₁₋₄) may be prepared. In one or more embodiments, an end user (e.g., a non-bot human; can be agent 312₁₋₂ or another end user) may provide the aforementioned mapping. In one or more embodiments, in the MCTS algorithm, combinatorial spaces represented by trees (e.g., tree data structures) may be searched, wherein nodes of the trees denote states that are configurations of the problem and edges denote transitions (or, actions) from one state to another. In one or more embodiments, the aforementioned mapping may be stored in a database 490 (e.g., associated with or part of memory 404 and/or memory 424) as state-consideration mapping 492. In one or more embodiments, then an empty training dataset (e.g., training dataset 494) may be initialized, signaling completion of the preparation phase.

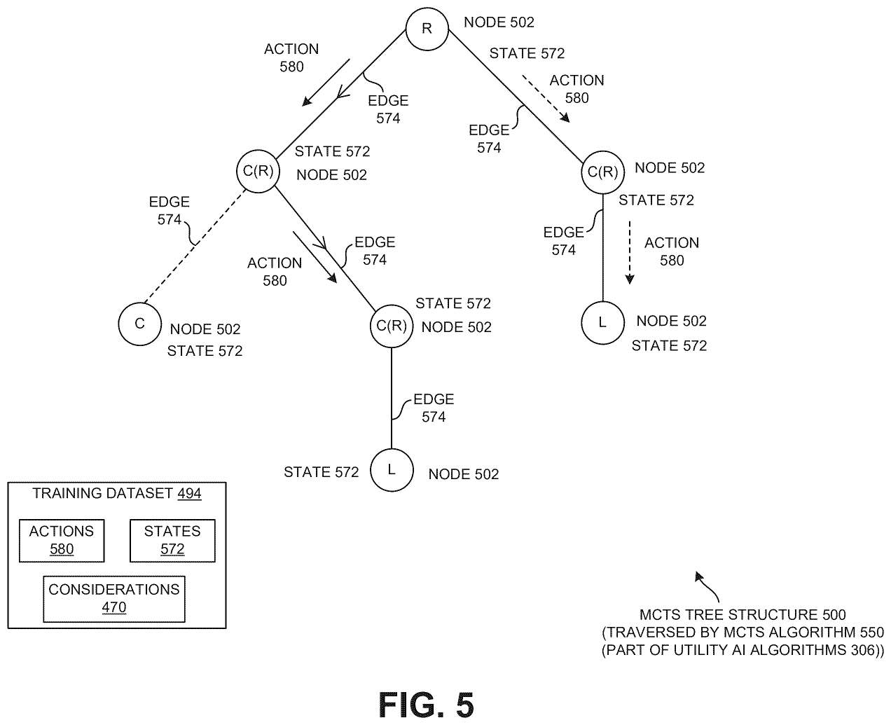

In one or more embodiments, generation of training dataset 494 (e.g., part of data 308) may then commence. In one or more embodiments, utilizing MCTS-based agents 312₁₋₂, N full games may be played. In one or more embodiments, at each decision point in the game, agent 312₁₋₂ may execute M iterations of the MCTS algorithm, with the number of iterations directly influencing the strength thereof. In one or more embodiments, through these M iterations, agents 312₁₋₂ may play the virtual simulations on state copies (e.g., state copies 430 in memory 424/404) thereof, distinct from the main game simulation. FIG. 5 shows example nodes 502 of an MCTS tree structure 500. In one or more embodiments, nodes 502 may encompass root nodes (R), child nodes (C) and a leaf node (L). The leaf node (L) may be a node or nodes for which there are no child nodes (C). A child node (C) may also be a leaf node (L), as shown in FIG. 5. If L does not realize an end state in a game, an L node may be further expanded into one or more child nodes (C) until the end state is determined in which the MCTS algorithm (e.g., MCTS algorithm 550, part of utility AI algorithms 306) plays the game effectively from states associated with root nodes (R) to a leaf node (L) using a so-called selection policy, and from a leaf node (L) to the end by taking random decisions. The operations of the selection, expansion, simulation and back-propagation (e.g., updating nodes 502 based results found in the simulation phase) associated with MCTS algorithm 550 are known to one skilled in the art. Detailed discussion associated therewith has been skipped for the sake of clarity, brevity and convenience. As shown in FIG. 5 and discussed above, nodes 502 may denote states 572 that are configurations of the problem and edges 574 denote transitions (or actions) from one state 572 to another state 572.

In one or more embodiments, after each decision point in each full game simulation, nodes 502 of MCTS tree structure 500 may be traversed as constructed through MCTS algorithm 550. In one or more embodiments, from nodes 502 visited at least X<=M times, where X represents a confidence threshold (e.g., set manually, dynamically), a game state 572 corresponding to these nodes 502 and values of considerations 470 thereof may be extracted and highest evaluated actions 580 (e.g., transitions between states 572; in memory 424/404) selected. In one or more embodiments, the aforementioned data may be appended to training dataset 494, as shown in FIG. 4. Thus, in one or more embodiments, after N full games, N times an average number of decision steps across the games may be present as a number of entries in training dataset 494. In one or more embodiments, this may end the phase of generation of training dataset 494. Thus, in one or more embodiments, training dataset 494 may be populated with data corresponding to particular states occurring at least a threshold (e.g., X) number of times during the execution of utility AI algorithms 306/MCTS algorithm 550.

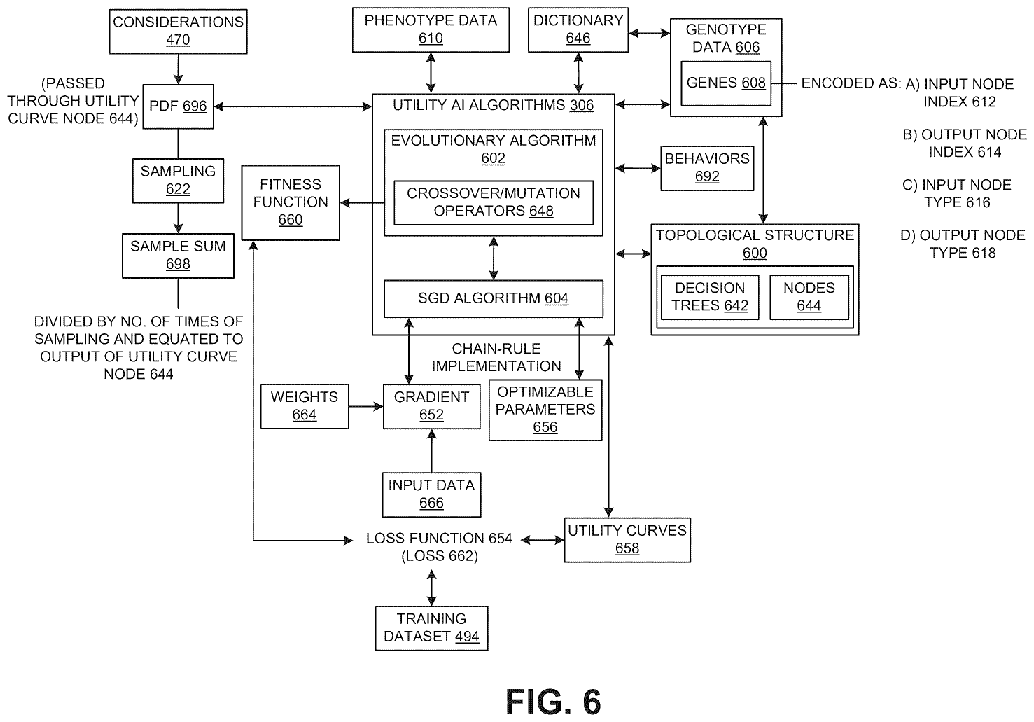

In one or more embodiments, the completion of the generation of training dataset 494 may enable the training of utility AI model 310 to be accomplished. While neural network-based training algorithms are readily available, exemplary embodiments discussed herein may enable customization of the existing structure of utility AI models and training algorithms to make them workable/trainable. In one or more embodiments, the training process may have a two-level hierarchy thereof. In one or more embodiments, at a higher level, the training may be executed through an evolutionary algorithm 602 (e.g., a genetic algorithm), as shown in FIG. 6, and, at a lower level, the training may be executed through a stochastic gradient descent (SGD)-based algorithm (e.g., SGD algorithm, 604) that uses back-propagation. While FIG. 6 shows both evolutionary algorithm 602 and SGD algorithm 604 as separate algorithms within utility AI algorithms 306, it should be noted that one algorithm may be part of the other.

In one or more embodiments, a topological structure 600 (analogous to topological structure 100) of utility AI model 310 may be encoded (e.g., using variable-length encoding); here, utility AI model 310 may be created using gaming/simulation platform engine 450 or may be an existing model that is utilized for encoding utility AI model 310. In one or more embodiments, evolutionary algorithm 602 discussed above may be a genetic algorithm that includes a population of candidate solutions for a problem, and evolves to find the optimum solution out of the candidates in accordance with applying stochastic operator(s) iteratively. In one or more embodiments, a genotype (e.g., represented by genotype data 606) may represent the population in the computation space and may be a set of parameters defining a proposed solution to a problem solved by evolutionary algorithm 602. For example, the genotype may have one or more strings (and even other data structures) associated therewith that may have a phenotype encoded thereto. Encoding, as discussed herein, may be a process of transforming a phenotype space to a genotype space.

In one or more embodiments, the genotype (or, genotype data 606) may include a set of genes 608, each of which are one or more encoded parameters called decision variables that determine and/or influence one or more phenotype characteristics. In one or more embodiments, the phenotype (e.g., represented by phenotype data 610) may be an expression of the genotype in a real-world problem space, and may result from the decoding of the genotype space. In one or more embodiments, evolutionary algorithm 602 may also construct decision trees 642 (e.g., analogous to MCTS tree structure 500) that have nodes 644 (analogous to nodes 502) associated therewith. In one or more embodiments, genes 608 may represent connections in the form of decision variables and may be encoded as four integer values: a) index of an input node 644, input node index 612, b) index of an output node 644, output node index 614, c) type of the input node 644, input node type 616, and d) type of the output node 644, output node type 618. Thus, the encoding of the genotype may occur as a series of the aforementioned connections.

In one or more embodiments, negative values (e.g., −1) may be used if there are no input or output nodes 644 for a given connection, i.e., gene 608. In one or more embodiments, the logic behind the types of the input and output nodes 608 may be implemented using a dictionary 646 that maps an integer value to a unique description, for example, 2 to a utility curve node 644 and 11 to an aggregator node 644 with sum as an aggregation operation.

In one or more embodiments, the available types may be: one unique type per available consideration 470, one unique type per available aggregator (analogous to aggregators 106₁₋₂) different types for different aggregation operations), and a selector (analogous to selector 108) that has a fixed argument (e.g., MAX) passed thereto. In one or more embodiments, the encoding of the genotype utilizes a phenotype-based validator that constructs the actual utility AI model (e.g., utility AI model 310) and checks whether the encoding represents a valid topological structure (e.g., topological structure 600). In one or more embodiments, crossover and mutation operators (e.g., crossover/mutation operators 648; part of evolutionary algorithm 602) may be utilized to modify a current topological structure (e.g., topological structure 100, topological structure 600), for example, by adding connections, removing connections, rewiring connections between the nodes (e.g., nodes 644/502) and/or changing types of the nodes.

In one or more embodiments, each individual in the population may have an actual utility AI model attached thereto based on a “blueprint” represented by encoding thereof. In one or more embodiments, the utility AI model may be created each time the encoding changes. In one or more embodiments, utility AI model 310 may be created based on the blueprint and the optimization of utility curves using SGD (e.g., implemented through SGD algorithm 604) and/or back-propagation. In one or more embodiments, SGD and/or back-propagation may require being able to calculate a gradient 652 of a loss function 654 with respect to optimizable parameters 656. In one or more embodiments, each utility curve may be represented as an interpolating curve through J control points. For example, while J may be a parameter set by a human at a later point in time, J may be a parameter initially set randomly and then automatically by utility AI algorithms 306. In one or more embodiments, the aforementioned interpolating curve may be piecewise linear, a constant function, a step function, a linear function, a power function, an exponential function, a sigmoid function, a staircase function and/or a Bezier curve (e.g., Bezier splines).

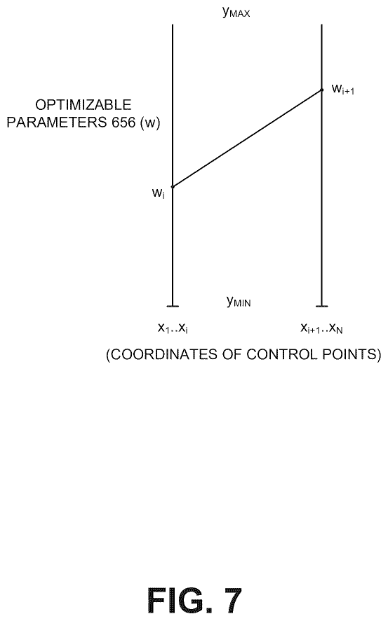

FIG. 7 shows optimizable parameters 656 (w) indexed as i and i+1 that are analogous to weights in neural networks; x (indexed as 1 . . . i and i+1 . . . N) may be coordinates of subsequent control points and yᵢ may represent values of the utility function (e.g., part of utility curves 658). In one or more embodiments, loss function required for back-propagation and the fitness function (e.g., fitness function 660) in evolutionary algorithm 602 may essentially be the same; however, in evolutionary algorithm 602, loss 662 may be calculated on the entire training dataset 494, in contrast to the back-propagation wherein the loss may be calculated on a given subset of training dataset 494. In one or more embodiments, the loss function may be a normalized value over a given set of values of per instance losses. In one or more embodiments, per instance loss may be computed for a given state within training dataset 494.

Let aₜ denote an action in training dataset 494 and a_{c} denote an action chosen by the currently trained utility AI model 310. If aₜ=a_{c}, the loss (e.g., per instance loss) may be 0 for the given training instance. Otherwise, the loss may be the difference between a utility function (e.g., part of utility curves 658). associated with aₜ and the utility function (e.g., part of utility curves 658) associated with a_{c} scaled by a minimum non-zero loss. In one or more embodiments, the back-propagation discussed herein may utilize a generalized chain rule to compute gradients 652 with respect to weights 664 and input data 666. In one or more embodiments, for aggregators 106₁₋₂, while gradient 652 may typically be computed with respect to input data 666 thereto, gradient 652 may only be propagated through the connection thereof that corresponds to a maximum and a minimum value in a forward pass corresponding to a maximum and minimum function to which weight aggregation is applied. In one or more embodiments, selector 108 may be removed from the back-propagation and the output of aggregator 106₁₋₂ may be a vector of inputs to selector 108. For example, [0,0,0,1] may represent a context in which a fourth action was chosen. In one or more embodiments, the loss for the vector of values representing the inputs to selector 108 may be computed.

In one or more embodiments, back-propagation may adjust weights wᵢ (e.g., weights 664) of control points, as shown in FIG. 7, and may be performed in an SGD fashion for a given number of iterations. In one or more embodiments, each iteration may represent utilization of each training sample from training dataset 494 once; training samples may be used in batches such that the sum of all batches may constitute the entire training dataset 494. In one or more embodiments, after the phase of back-propagation, a local normalization procedure may be executed that proportionally clamps all weights in utility AI model 310 to [0,1]. In one or more embodiments, the fitness of the entire utility AI model 310 may be calculated and attached to the genotype.

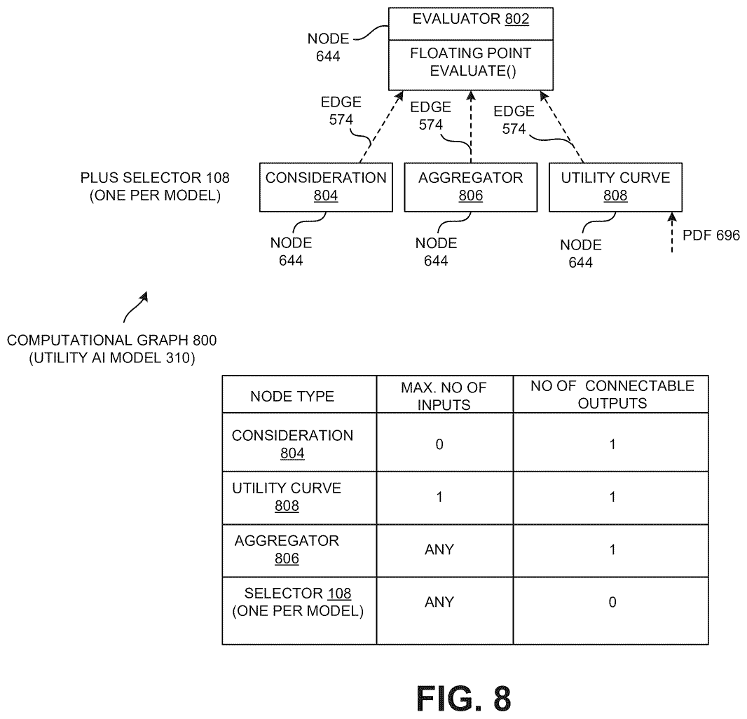

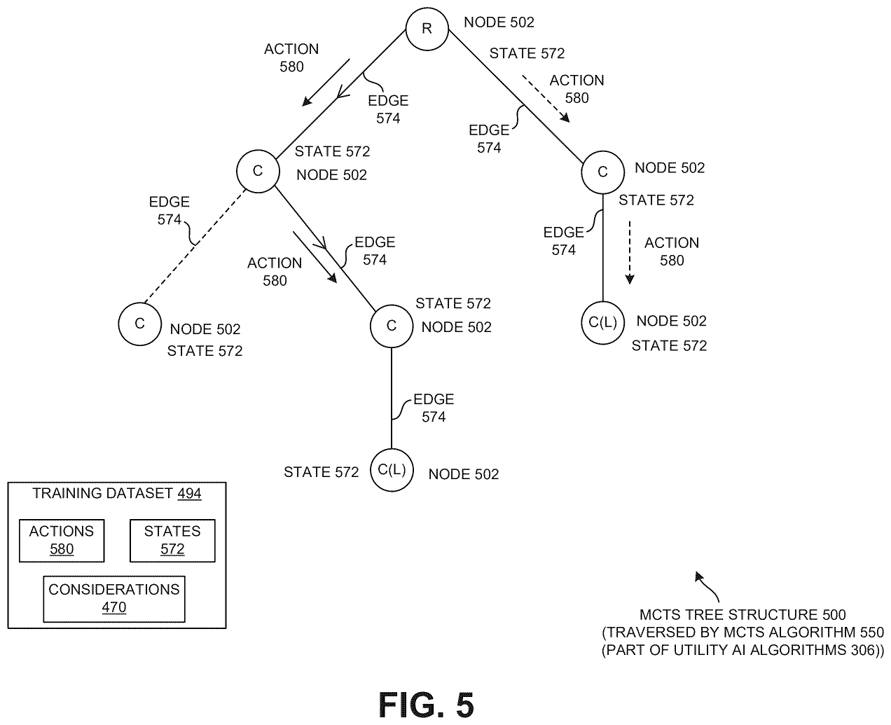

In one or more embodiments, the example topological structure 600/100 utilized in utility AI model 310 may be broadened into representation of utility AI model 310 as a general computational graph. Thus, in one or more embodiments, utility AI model 310 may no longer require the strictures of topological structure 100 shown in FIG. 1. In one or more embodiments, as implemented through utility AI algorithms 306 and shown in FIG. 8, an abstract evaluator object (e.g., evaluator 802) may be introduced to provide a parameter-less Evaluate( ) function that returns a floating point value as a score by considering data stored inside a context. In one or more embodiments, evaluator 802 may be inherited by objects representing consideration 804 (e.g., analogous to consideration 470), aggregator 806 (e.g., analogous to aggregator 106₁₋₂) and a utility curve 808 (analogous to utility curves 658), whereby consideration 804, aggregator 806 and utility curve 808 are specific instances of evaluator 802 or trees of connected evaluators (e.g., including evaluator 802).

In one or more embodiments, utility AI model 310 may thus be represented as a computational graph 800, wherein a node (e.g., node 644) thereof is an evaluator 802 (or a selector analogous to selector 108), and an edge (e.g., analogous to edges 574; each input numeric value and each output numeric value associated with consideration nodes 644, utility curve nodes 644 and aggregator nodes 644 may be represented as edges 574 of computational graph 800) represents flow of value. In one or more embodiments, nodes 644 may be automatically devised based on a defined topology (e.g., topological structure 600) of computational graph 800. In one or more embodiments, nodes may be connected to computational graph 800 as long as a number of inputs thereto is not exceeded. FIG. 8 also shows an example maximum number of inputs and a number of connectable outputs to computational graph 800.

It should be noted that a node 644 associated with selector 108 may process outputs of nodes 644 associated with aggregators 106₁₋₂/806 and a set of behaviors (e.g., behaviors 692) applicable to the virtual environment (e.g., virtual gaming/simulation environment 480) in accordance with magnitudes of input numeric values associated therewith. In one or more embodiments, the greater the magnitude of an input numeric value, the greater the chance that behavior 692 (e.g., appropriate behavior of agent 312₁₋₂ with respect to virtual gaming/simulation environment 480) associated therewith may be selected through selector 108. Also, in one or more embodiments, each consideration 804 may either directly map a subset of game states (e.g., states 572) to a numeric value (e.g., floating point value) and/or may be represented as a probability density function (PDF 696) that denotes the probability of a given numeric value.

In one or more embodiments, PDF 696 may be transferred through each utility curve node 644 such that each value of a probability distribution associated with PDF 696 is sampled (e.g., sampling 622) proportionally a number of times to a probability thereof. In one or more embodiments, a result of the summing (e.g., sample sum 698) divided by the number of times of the sampling may be equated to an output from each utility curve node 644. In one or more embodiments, PDF may be transferred through the each aggregator node 644 and/or the selector node 644 and the each aggregator node 644 and/or the selector node 644 replaced with an expected value that is treated as a new input to the each aggregator node 644 and/or the selector node 644. In one or more embodiments, an output edge (edge 574; or, output) of evaluator 802 may be iteratively obtained until the appropriate behavior of agent 312₁₋₂ is selected (e.g., using selector 108).

In one or more embodiments, fitness function 660 may be utilized based on loss function 654 that measures difference between an output associated with inferring computational graph 800 represented as a genotype and another output gathered in a dataset (e.g., training dataset 494) selected as the appropriate behavior of agent 312₁₋₂. It should be noted that concepts associated with genetic algorithms, evolutionary algorithms, back-propagation and SGD are known to one skilled in the art. Detailed discussion associated therewith has been skipped for the sake of clarity and brevity. Also, it should be noted that all operations discussed herein may be based on execution of utility AI algorithms 306 on one or more data processing devices 302_{1-N} (e.g., even encompassing VMs); all results of the operations discussed herein may be regarded as part of data 308. All reasonable variations are within the scope of the exemplary embodiments discussed herein.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., one or more data processing device(s) 302_{1-N}), and may be performed in any order (e.g., including using means for achieving the various operations). Accordingly, the specification and drawings are to be regarded in an illustrative rather than a restrictive sense.

What is claimed is:

1. A method of a data processing device executing at least one utility Artificial Intelligence (AI) algorithm comprising:
training, using the at least one utility AI algorithm, an adaptive utility AI model with data generated solely from a bot as an agent interacting with a virtual environment offered by at least one of: a gaming and a simulation application to generate a computational graph as the adaptive utility AI model in accordance with, implementing as part of the computational graph:
a plurality of consideration nodes that each has a state of the virtual environment input thereto and outputs a numeric value representative of the state of the virtual environment;
a plurality of utility curve nodes, each of which transforms the output numeric value into another numeric value;
a plurality of aggregator nodes, each of which has numeric values from a subset of the plurality of utility curve nodes input thereto and outputs exactly one numeric value therefrom; and
a selector node to process outputs of the plurality of aggregator nodes and a set of behaviors applicable to the virtual environment in accordance with magnitudes of input numeric values associated therewith; and
selecting, through the selector node, a behavior out of the set of behaviors applicable to the virtual environment as an appropriate behavior of the agent in the virtual environment in accordance with the implementation of the computational graph.

2. The method of claim 1, comprising at least one of:
representing each input numeric value and output numeric value associated with the plurality of consideration nodes, the plurality of utility curve nodes and the plurality of aggregator nodes as edges of the computational graph; and
enabling connection of each edge of the edges of the computational graph to any node thereof as long as a number of possible connections thereof is not exceeded.

3. The method of claim 1, comprising at least one of:
implementing inheritance in the computational graph such that the plurality of consideration nodes, the plurality of utility curve nodes and the plurality of aggregation nodes inherit from a same object, which renders the each consideration node, the each utility curve node and the each aggregator node as specific instances of the same object;
at least one of: directly mapping, via each consideration associated with the plurality of consideration nodes, a subset of states of the virtual environment into at least one floating point value and representing the each consideration as a probability density function;
transferring the probability density function through the each utility curve node such that each value of a probability distribution associated with the probability density function is sampled proportionally a number of times to a probability thereof; and
summing a result of the sampling to equate an output from the each utility curve node to the summed result divided by the number of times of the sampling.

4. The method of claim 3, further comprising transferring the probability density function through at least one of: the each aggregator node and the selector node and replacing the each aggregator node and the selector node with an expected value that is treated as a new input to the at least one of: the each aggregator node and the selector node.

5. The method of claim 3, comprising at least one of:
the at least one utility AI algorithm assigning the numeric values to the plurality of consideration nodes based on a current state of the virtual environment; and
iteratively obtaining an output edge of the same object until the appropriate behavior of the agent is selected.

6. The method of claim 5, comprising at least one of:
automatically devising the plurality of consideration nodes, the plurality of utility curve nodes, the plurality of aggregator nodes and the selector node based on a defined topology of the computational graph; and
executing the at least one utility AI algorithm in a slowed down version of the virtual environment in accordance with:
executing N complete interactions with the slowed down version of the virtual environment;
obtaining consideration values relevant to the plurality of consideration nodes during the N complete interactions; and
populating the data with which the utility AI model is trained with datasets corresponding to particular states occurring at least a threshold number of times during the execution of the at least one utility AI algorithm in the slowed down version of the virtual environment.

7. The method of claim 6, comprising at least one of:
utilizing a combination of an evolutionary algorithm and a back-propagation algorithm in the generation of the computational graph;
utilizing encoding of genotypes as a set of connections, with each connection represented by four integer values that are an index of an input node, a type of the input node, an index of an output node and a type of the output node associated with the evolutionary algorithm;
utilizing a fitness function based on a loss function that measures difference between an output associated with inferring the computational graph represented as a genotype and another output gathered in a dataset as the appropriate behavior of the agent;
representing each utility curve associated with the each utility curve node as an interpolating curve; and
executing the back-propagation algorithm with a stochastic gradient descent algorithm that uses the datasets and the loss function.

8. A data processing device comprising:
a memory comprising instructions associated with at least one utility AI algorithm stored therein; and
a processor communicatively coupled to the memory to execute the instructions associated with the at least one utility AI algorithm stored in the memory to:
train an adaptive utility AI model with data generated solely from a bot as an agent interacting with a virtual environment offered by at least one of: a gaming and a simulation application to generate a computational graph as the adaptive utility AI model in accordance with, implementing as part of the computational graph:
a plurality of consideration nodes that each has a state of the virtual environment input thereto and outputs a numeric value representative of the state of the virtual environment,
a plurality of utility curve nodes, each of which transforms the output numeric value into another numeric value,
a plurality of aggregator nodes, each of which has numeric values from a subset of the plurality of utility curve nodes input thereto and outputs exactly one numeric value therefrom, and
a selector node to process outputs of the plurality of aggregator nodes and a set of behaviors applicable to the virtual environment in accordance with magnitudes of input numeric values associated therewith, and
select, through the selector node, a behavior out of the set of behaviors applicable to the virtual environment as an appropriate behavior of the agent in the virtual environment in accordance with the implementation of the computational graph.

9. The data processing device of claim 8, wherein the processor executes instructions associated with the at least one utility AI algorithm to at least one of:
represent each input numeric value and output numeric value associated with the plurality of consideration nodes, the plurality of utility curve nodes and the plurality of aggregator nodes as edges of the computational graph, and
enable connection of each edge of the edges of the computational graph to any node thereof as long as a number of possible connections thereof is not exceeded.

10. The data processing device of claim 8, wherein the processor executes instructions associated with the at least one utility AI algorithm to at least one of:
implement inheritance in the computational graph such that the plurality of consideration nodes, the plurality of utility curve nodes and the plurality of aggregation nodes inherit from a same object, which renders the each consideration node, the each utility curve node and the each aggregator node as specific instances of the same object,
at least one of: directly map, via each consideration associated with the plurality of consideration nodes, a subset of states of the virtual environment into at least one floating point value and represent the each consideration as a probability density function,
transfer the probability density function through the each utility curve node such that each value of a probability distribution associated with the probability density function is sampled proportionally a number of times to a probability thereof, and
sum a result of the sampling to equate an output from the each utility curve node to the summed result divided by the number of times of the sampling.

11. The data processing device of claim 10, wherein the processor further executes instructions associated with the at least one utility AI algorithm to transfer the probability density function through at least one of: the each aggregator node and the selector node and replace the each aggregator node and the selector node with an expected value that is treated as a new input to the at least one of: the each aggregator node and the selector node.

12. The data processing device of claim 10, wherein the processor executes instructions associated with the at least one utility AI algorithm to at least one of:
assign the numeric values to the plurality of consideration nodes based on a current state of the virtual environment, and
iteratively obtain an output edge of the same object until the appropriate behavior of the agent is selected.

13. The data processing device of claim 12, wherein the processor executes instructions associated with the at least one utility AI algorithm to at least one of:
automatically devise the plurality of consideration nodes, the plurality of utility curve nodes, the plurality of aggregator nodes and the selector node based on a defined topology of the computational graph, and
execute the at least one utility AI algorithm in a slowed down version of the virtual environment in accordance with:
executing N complete interactions with the slowed down version of the virtual environment,
obtaining consideration values relevant to the plurality of consideration nodes during the N complete interactions, and
populating the data with which the utility AI model is trained with datasets corresponding to particular states occurring at least a threshold number of times during the execution of the at least one utility AI algorithm in the slowed down version of the virtual environment.

14. The data processing device of claim 13, wherein the processor executes instructions associated with the at least one utility AI algorithm to at least one of:
utilize a combination of an evolutionary algorithm and a back-propagation algorithm in the generation of the computational graph,
utilize encoding of genotypes as a set of connections, with each connection represented by four integer values that are an index of an input node, a type of the input node, an index of an output node and a type of the output node associated with the evolutionary algorithm,
utilize a fitness function based on a loss function that measures difference between an output associated with inferring the computational graph represented as a genotype and another output gathered in a dataset as the appropriate behavior of the agent,
represent each utility curve associated with the each utility curve node as an interpolating curve, and
execute the back-propagation algorithm with a stochastic gradient descent algorithm that uses the datasets and the loss function.

15. A computing system comprising:
a server comprising instructions associated with at least one utility AI algorithm stored therein; and
a client device communicatively coupled to the server,
wherein the server executes the instructions associated with the at least one utility AI algorithm to:
train an adaptive utility AI model with data generated solely from a bot as an agent at the client device interacting with a virtual environment offered by at least one of: a gaming and a simulation application to generate a computational graph as the adaptive utility AI model in accordance with, implementing as part of the computational graph:
a plurality of consideration nodes that each has a state of the virtual environment input thereto and outputs a numeric value representative of the state of the virtual environment,
a plurality of utility curve nodes, each of which transforms the output numeric value into another numeric value,
a plurality of aggregator nodes, each of which has numeric values from a subset of the plurality of utility curve nodes input thereto and outputs exactly one numeric value therefrom, and
a selector node to process outputs of the plurality of aggregator nodes and a set of behaviors applicable to the virtual environment in accordance with magnitudes of input numeric values associated therewith, and
select, through the selector node, a behavior out of the set of behaviors applicable to the virtual environment as an appropriate behavior of the agent in the virtual environment in accordance with the implementation of the computational graph.

16. The computing system of claim 15, wherein the server executes instructions associated with the at least one utility AI algorithm to at least one of:
represent each input numeric value and output numeric value associated with the plurality of consideration nodes, the plurality of utility curve nodes and the plurality of aggregator nodes as edges of the computational graph, and
enable connection of each edge of the edges of the computational graph to any node thereof as long as a number of possible connections thereof is not exceeded.

17. The computing system of claim 15, wherein the server executes instructions associated with the at least one utility AI algorithm to at least one of:
implement inheritance in the computational graph such that the plurality of consideration nodes, the plurality of utility curve nodes and the plurality of aggregation nodes inherit from a same object, which renders the each consideration node, the each utility curve node and the each aggregator node as specific instances of the same object,
at least one of: directly map, via each consideration associated with the plurality of consideration nodes, a subset of states of the virtual environment into at least one floating point value and represent the each consideration as a probability density function,
transfer the probability density function through the each utility curve node such that each value of a probability distribution associated with the probability density function is sampled proportionally a number of times to a probability thereof,
sum a result of the sampling to equate an output from the each utility curve node to the summed result divided by the number of times of the sampling, and
transfer the probability density function through at least one of: the each aggregator node and the selector node and replace the each aggregator node and the selector node with an expected value that is treated as a new input to the at least one of: the each aggregator node and the selector node.

18. The computing system of claim 17, wherein the server executes instructions associated with the at least one utility AI algorithm to at least one of:
assign the numeric values to the plurality of consideration nodes based on a current state of the virtual environment, and
iteratively obtain an output edge of the same object until the appropriate behavior of the agent is selected.

19. The computing system of claim 18, wherein the server executes instructions associated with the at least one utility AI algorithm to at least one of:
automatically devise the plurality of consideration nodes, the plurality of utility curve nodes, the plurality of aggregator nodes and the selector node based on a defined topology of the computational graph, and
enable execution of the at least one utility AI algorithm in a slowed down version of the virtual environment in accordance with enabling, through the at least one of: the gaming and the simulation application:
executing N complete interactions with the slowed down version of the virtual environment,
obtaining consideration values relevant to the plurality of consideration nodes during the N complete interactions, and
populating the data with which the utility AI model is trained with datasets corresponding to particular states occurring at least a threshold number of times during the execution of the at least one utility AI algorithm in the slowed down version of the virtual environment.

20. The computing system of claim 19, wherein the server executes instructions associated with the at least one utility AI algorithm to at least one of:
utilize a combination of an evolutionary algorithm and a back-propagation algorithm in the generation of the computational graph,
utilize encoding of genotypes as a set of connections, with each connection represented by four integer values that are an index of an input node, a type of the input node, an index of an output node and a type of the output node associated with the evolutionary algorithm,
utilize a fitness function based on a loss function that measures difference between an output associated with inferring the computational graph represented as a genotype and another output gathered in a dataset as the appropriate behavior of the agent,
represent each utility curve associated with the each utility curve node as an interpolating curve, and
execute the back-propagation algorithm with a stochastic gradient descent algorithm that uses the datasets and the loss function.
